(19) United States
(12) Patent Application Publication
(10) Pub. No.: US 2005/0019143 A1
(43) Pub. Date: Jan. 27, 2005

(54) Dolly and trailer jack combination and method of use

(76) Inventor: Michael Bishman, Orange, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/626,751

(22) Filed: Jul. 23, 2003

(51) Int. Cl. B60P 1/04

(52) U.S. Cl. 414/482

(57) ABSTRACT

A wheeled dolly is enabled for rolling movement on a supporting surface. A centrally positioned sidewall extends upwardly from an upfacing surface of the platform. A vertical jacking device is rested in contact with the supporting surface interior of the sidewall. The sidewall is tall enough so that a jack foot is restrained within the sidewall, and therefore not able to move laterally on the platform so as to tip it. A trailer is joined with the jacking device enabling manual movement of the trailer and its load by maneuvering the platform.

INCORPORATION BY REFERENCE: Applicant(s) hereby incorporate herein by reference, any and all U.S. patents, U.S. patent applications, and other documents and printed matter cited or referred to in this application.

### BACKGROUND OF THE INVENTION

1. Field of the Invention

This invention relates generally to wheeled dollys, low rolling hand trucks and the like and more particularly to such a device that is adapted particularly for engaging a trailer jack.

2. Description of Related Art

The following art defines the present state of this field: English, Jr., et al., U.S. Pat. No. 6,533,524, teaches a lift dolly for lifting and transporting stand-mounted power tools and the like, with little effort. The dolly includes a pair of platforms and a wheel system having at least three castors extending downwardly from the platforms. The dolly is designed such that one step onto a latching or locking mechanism by the operator causes the wheel system to be forced downward relative to the stand thereby slightly lifting the power tool and stand off of the ground and enabling transport of same via the castors. Another step on the locking or latching mechanism disengages the wheel system and permits gravity to return the stand and tool firmly to the ground for use.

Calender, U.S. Pat. No. 6,386,560, teaches a dolly for large appliances facilitating manual movement of soft drink vending machines, refrigerators, etc. The dolly has a dropped floor between each end, with the ends raised for installation of casters therebeneath. The lower central floor area is preferably only about 1.5 inches above the lower supporting surface when the dolly is resting thereon, thereby allowing a large machine to be tilted slightly and the dolly maneuvered therebeneath. The low floor also results in a very low ride height for the appliance, enabling the appliance to fit upright through a standard doorway. Carrying the appliance sideways on the dolly, also permits large vending machines to fit through a standard doorway by opening the door of the machine to narrow the effective width of the machine. A roller lever is also provided, for lifting one end of the loaded dolly for maneuvering the lifted end across thresholds and other floor discontinuities.

Hamlett, U.S. Pat. No. 6,357,991, teaches an apparatus for transporting, loading and unloading a watercraft, such as a jet ski, or wheeled vehicle from the bed of a pick up truck, where the apparatus is convertible to a mobile dolly for storage of the jet ski or other object. The apparatus comprises a tiltable mechanism formed of a pair of spaced apart rails mounting a pair of pivotal and retractable legs at a first end, a winch mechanism at the opposite end, and a longitudinally movable and pivotal leg support mechanism, movable from the first end to near the opposite end.

Wintz, U.S. Pat. No. 5,938,217, teaches a load handling dolly which assists in the transportation of a load P, such as a piano. A pair of cross-pieces are selectively slid beneath the load, either directly or using an intermediate support plate. A pair of side frames are disposed on either side of the load above free ends of the cross-pieces. The cross-pieces are received within extremities or eyelets of tie rods which are supported by the side frames for vertical movement by rotating a nut. As the nuts are turned, the tie rods, cross-pieces, and the load are lifted, transferring the load to two sets of wheels that rotatably mounted in the side frames.

Hull, et al., U.S. Pat. No. 5,860,668, teaches a convertible chassis for a dual axle semitrailer for converting the semitrailer to a single axle trailer having an attached dolly to pull a second trailer thereon.

Combs, Sr., U.S. Pat. No. 6,203,264, teaches A post-and-beam mechanism easily connectable to a standard car dolly carries on its beams a standard boat trailer, loaded with boat and outboard motor, above the front end of a towed vehicle on the dolly, with the rear, heavy end of the trailer and boat located forward most. A motor home may tow, to the destination site, the dolly thus loaded with towed vehicle, boat trailer, boat and motor. The post-and-beam mechanism is pivotably swingable from a low position for loading the loaded boat trailer thereon; to a high position for carrying the loaded boat trailer. The towing is safely done, with advantageous forward weight distribution of the carried trailer, boat and motor, and with short combined overall length of towing vehicle and towed vehicle, for easy driving and parking. When the destination site is reached, the towed vehicle is unloaded from the car dolly, and the mechanism may be lowered from the high position to the low position for unloading the boat trailer. An arrangement of pull pins and cotter keys enable part of the post-and beam mechanism to stay attached to the boat trailer, enables part to be easily disconnected and set aside, and enables the rest to remain attached to the car dolly. This permits convenient and separate independent usage of either the car dolly or the boat trailer with either the towing vehicle or the towed vehicle, or with other vehicles at or near the destination site.

The prior art teaches a lift dolly for use in conjunction with stand-mounted power tools and the like, a lift dolly for heavy appliances, a combination watercraft transportation system and dolly, a combination watercraft transportation system and dolly, a boat trailer carrier for an over car dolly, and a dolly for moving pianos and other heavy goods, but does not teach a combination dolly and vertical jacking device wherein the jacking device is affixed to a trailer, such as a boat trailer, with simple sidewalls for assuring engagement between the dolly and the jacking device as lateral forces are applied. The present invention fulfills these needs and provides further related advantages as described in the following summary.

### SUMMARY OF THE INVENTION

The present invention teaches certain benefits in construction and use which give rise to the objectives described below.

A horizontal platform dolly is mounted on plural wheels, and is thereby enabled for rolling movement on a supporting surface. A sidewall extends upwardly from an upfacing surface of the platform. A vertical jacking device is positioned in contact with the supporting surface interior of the sidewall. The sidewall is tall enough so that the jacking device is restrained within the sidewall, and therefore not able to move laterally off the platform or to tip it. A trailer is joined with the jacking device enabling manual movement of the trailer and its load by maneuvering the platform on the supporting surface.

A primary objective of the present invention is to provide an apparatus and method of use of such apparatus that provides advantages not taught by the prior art.

Another objective is to provide such an invention capable of supporting the weight of a trailer and a trailer load in rolling motion.

A further objective is to provide such an invention capable of manually moving a significant load, laterally, without the necessity of bolting or otherwise attaching a jacking device to a dolly.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawing illustrate the present invention. In such drawing:

FIG. 1 is a perspective view of the preferred embodiment of the invention with a partial cutaway providing detail.

### DETAILED DESCRIPTION OF THE INVENTION

The above described drawing figures illustrate the invention in at least one of its preferred embodiments, which is further defined in detail in the following description.

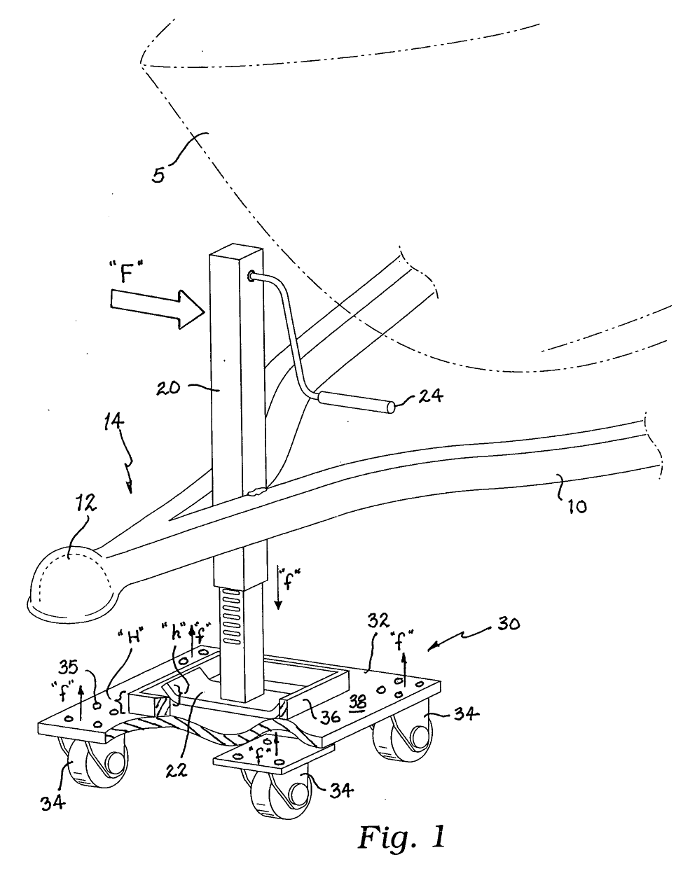

The present invention is an apparatus comprising the combination of a trailer 10 with a vertical jacking device 20 and a rolling platform dolly 30. The trailer 10 provides a hitching device 12 at its forward terminal end 14. The jacking device 20 is of the type manufactured by Fulton-Wesbar, Inc. as model 35sp28f and has a crank 24 for moving a supporting foot 22 vertically, as is well known in the art. The device 20 is fixedly engaged with the trailer 10 adjacent to the hitching device 12 preferably by welding so that the jacking device 20 is rigidly attached to the trailer 10 in a vertical attitude, as clearly shown in FIG. 1. The rolling dolly 30 is preferably made of steel plate of high structural strength and is rolled into place under the jacking device 20 prior to disconnecting the trailer 10 from a towing vehicle (not shown). A jack foot 22 of the jacking device 20 is lowered, using crank 24 until the rolling dolly 30 supports the weight of the trailer 10 and its load 5. Once this is accomplished, the hitching device 12 is able to be disconnected from the towing vehicle and the towing vehicle may be moved away from the trailer 10.

The dolly 30 provides a horizontal platform 32 mounted on plural wheels 34 so that it is enabled for rolling on a supporting surface such as a driveway or garage floor. The wheels 34 are preferably attached to the platform 32 by bolts or rivets 35. A sidewall 36 is integral with, and extends upwardly from, an upfacing surface 38 of the platform 32. In FIG. 1 the platform 32 is cut away to show detail. FIG. 1 intends to show that the platform 32 is square or rectangular, although other shapes would function equally as well.

The vertical jacking device 20 has a jack foot 22, as stated, which is fixedly attached at the bottom terminal end of the jacking device 20, and this jack foot 22 is positioned and rested in contact with the supporting surface 38 interior of a sidewall 36 which is integral with platform 32. The sidewall 40 has a height “H” superior to a height “h” of the jack foot so that the jack foot 22 is motion restrained within the sidewall 36. “H” and “h” are both shown in FIG. 1 and it is pointed out that jack foot 22 is not able to slide laterally out of contact with surface 38 due to the sidewall 40 which acts as an obstruction to such motion of jack foot 22. It is also pointed out that jack foot 22 is not joined with platform 32 in any way. However jack foot 22 bears the weight of trailer 10 and load 5 so that there is normally considerable downward force pressing jack foot 22 against surface 38. Sidewall 36 is shown partially cut-away in order to show detail of how the jack foot 22 is fitted within sidewall 36. Preferably sidewall 40 forms a closed figure; in the figure, a square, but it should be realized that sidewall 36 may form an open figure, may be other than rectangular or square and, in fact, need not be continuous; as for instance being made up of a series of sidewall portions. Sidewall 36 may for instance be made up of a series of spaced pegs extending upwardly from surface 38. However, in order to assure that jack foot 22 is not able to slide along surface 38 or slide off dolly 30 when a lateral horizontal force (“F” in FIG. 1) is applied, sidewall 36 preferably fully surrounds the area on surface 38 where jack foot 22 is placed. In this manner, horizontal force “F” may be applied in any direction without fear of sliding jack foot 22 off dolly 30, or of sliding jack foot 22 away from a central position on dolly 30 whereby dolly 30 may be overturned or become unstable.

Preferably, the platform 32 is rectangular or square and the plural wheels 34 include four caster wheels, one of the caster wheels positioned on each one of four comers of the rectangular platform 32. This arrangement is clearly shown in FIG. 1.

Preferably, the sidewall 36 is positioned relative to the caster wheels 34 such that a downward force “f” on the vertical jacking device is transferred to the platform 32 at an interior position relative to upward support forces “f” on the platform exerted by the caster wheels 34. Clearly, as long as downward force “f” is within the rectangle formed by the upward forces “f” the dolly 30 will remain stable. In fact, the location of sidewall 36 is such that jack foot 22 and therefore downward force “f” is well centered in the rectangle formed by the upward forces “f.”

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. An apparatus comprising in combination: a horizontal platform mounted on plural wheels, for rolling movement on a supporting surface; a sidewall integral with, and extending upwardly from an upfacing surface of the platform; and a vertical jacking device having a jack foot positioned in contact with the supporting surface interior of the sidewall, the sidewall having a height superior to a height of the jack foot so that the jack foot is restrained within the sidewall.

2. The apparatus of claim 1 further comprising a trailer rigidly engaged medially with the vertical jack whereby the vertical jack supports a load on the trailer.

3. The apparatus of claim 1 wherein the platform is rectangular, the plural wheels comprising four caster wheels, one of the caster wheels positioned adjacnet each one of four comers of the rectangular platform.

4. The apparatus of claim 3 wherein the sidewall is positioned relative to the caster wheels such that a downward force on the vertical jacking device is transferred to the platform interiorly relative to upward support forces on the platform exerted by the caster wheels.

5. An apparatus comprising: a horizontal platform mounted on plural wheels, for rolling movement on a supporting surface; a closed figure sidewall integral with, and extending upwardly from an upfacing surface of the platform; a vertical jacking device having a jack foot positioned in contact with the supporting surface interior of the sidewall, the sidewall having a height enabling lateral restraint of the jack foot motion, wherein the sidewall is positioned relative to the caster wheels such that a downward force on the vertical jacking device is transferred to the platform interior to upward support forces on the platform exerted by the caster wheels.

6. An apparatus comprising in combination: a horizontal platform mounted on plural wheels, for rolling movement on a supporting surface; a sidewall integral with, and extending upwardly from an upfacing surface of the platform; and a vertical jacking device having a jack foot positioned in contact with the supporting surface interior of the sidewall, the sidewall having a height superior to a height of the jack foot so that the jack foot is restrained within the sidewall and a trailer rigidly engaged with the vertical jack at a medial position thereon.

7. The apparatus of claim 6 wherein the trailer provides a trailer hitch proximal the vertical jack.

8. The apparatus of claim 6 wherein the platform is rectangular, the plural wheels comprising four caster wheels, one of the caster wheels positioned on each one of four comers of the rectangular platform.

9. The apparatus of claim 8 wherein the sidewall is positioned relative to the caster wheels such that a downward force on the vertical jacking device is transferred to the platform interior to upward support forces on the platform exerted peripherally by the caster wheels.

10. A method of providing rolling support and manual mobility to a trailer, the trailer initially connected to a towing vehicle by a hitch, the method comprising the steps of: positioning the trailer using the towing vehicle; raising a jack foot of a vertical jacking device attached to the trailer proximal the hitch; positioning a platform below the jack foot; lowering the jack foot into contact centrally on the platform within a sidewall positioned to restrain the jack foot within the sidewall, thereby transferring weight of the trailer from the hitch to the platform; disengaging the trailer from the towing vehicle at the hitch; displacing the towing vehicle; and positioning the trailer manually by moving the jacking device and trailer on wheels supporting the platform.
